(19) United States
(12) Patent Application Publication
(10) Pub. No.: US 2019/0277154 A1
(43) Pub. Date: Sep. 12, 2019

(54) VARIABLE VANE ACTUATION ARRANGEMENT

(71) Applicant: ROLLS-ROYCE plc, London (GB)

(72) Inventor: Robert J. KYLE, Derby (GB)

(73) Assignee: ROLLS-ROYCE plc, London (GB)

(21) Appl. No.: 16/281,558

(22) Filed: Feb. 21, 2019

(30) Foreign Application Priority Data
Mar. 7, 2018 (GB) 1803649.1

(51) Int. Cl. F01D 17/16; F01D 9/04

(52) U.S. Cl. CPC F01D 17/162; F01D 9/042; F05D 2260/74; F05D 2240/12; F05D 2220/32

(57) ABSTRACT

There is disclosed a variable vane actuation arrangement 100 comprising a unison ring 34 configured to pivot a plurality of variable vanes 26 and a drive assembly 102 for driving rotation of the unison ring 34, comprising a drive 104 and a flexible line 106 extending from a ring anchor point 110 on the unison ring 34 to the drive 104. The ring anchor point 110 is positioned such that a portion of the flexible line 106 extending towards the drive 104 wraps around the unison ring 34, whereby tension in the flexible line 106 is applied to the ring anchor point 110 in a direction tangential to the unison ring 34.

### CROSS-REFERENCE TO RELATED APPLICATIONS

This specification is based upon and claims the benefit of priority from UK Patent Application Number 1803649.1 filed on 7 Mar. 2018, the entire contents of which are incorporated herein by reference.

### BACKGROUND

### Technical Field

The present invention relates to a variable vane actuation arrangement for varying the pitch of variable stator vanes in a gas turbine engine.

### Description of the Related Art

Gas turbine engines comprise several stages of axial compression. In order to optimise performance of the engine, stator vanes may be configured to pivot to vary their pitch or angle of incidence with respect to the annulus flow through the engine.

One known arrangement for actuating such stator vanes is to provide a unison ring coupled to each of the stator rings and rotatable about a central axis of the engine to cause the stator vanes to pivot. One or more actuators with control rods acting on the unison ring may be disposed around the unison ring to drive rotation.

### SUMMARY

According to a first aspect, there is provided a variable vane actuation arrangement comprising: a unison ring moveable to vary the pitch of a plurality of variable vanes; and a drive assembly for driving rotation of the unison ring, comprising a drive and a flexible line extending from a ring anchor point on the unison ring to the drive; wherein the ring anchor point is positioned such that a portion of the flexible line extending towards the drive wraps around the unison ring, whereby tension in the flexible line is applied to the ring anchor point in a direction locally tangential to the unison ring.

In other words, the portion of the flexible line extending towards the drive lies circumferentially around and against the unison ring.

The unison ring may be configured to vary the pitch of the plurality of variable vanes by rotating the vanes about an axis that is substantially perpendicular to the axis about which the unison ring rotates. The unison ring may be rotatable about an axis that is substantially parallel to the axis of an axial flow gas turbine engine (or stage thereof). The pitch of the vanes may be varied by rotating the vanes about an axis that is substantially parallel to a radial direction of such an axial flow gas turbine engine (or stage thereof).

There may be a path tangential to the unison ring extending between a tangent point on the unison ring to the drive. The ring anchor point may be disposed on an opposing side of the tangent point from the drive so that the portion of the flexible line which wraps around the unison ring departs the unison ring at the tangent point.

The actuation arrangement may further comprise an actuator configured to actuate the drive.

The drive may be defined by a crankshaft. The drive assembly may comprise a flexible line extending from a crank anchor point on the crankshaft to the actuator. The crank anchor point may be positioned such that a portion of the flexible line extending towards the actuator wraps around the crankshaft, whereby tension in the flexible line is applied to the crank anchor point in a direction tangential to the crankshaft.

There may be a path tangential to the crankshaft extending between the unison ring and a crank tangent point on the crankshaft. The crank anchor point may be disposed on an opposing side of the crank tangent point from the unison ring so that a portion of the flexible line wraps around the crank anchor and departs the crank anchor at the crank tangent point.

There may be a plurality of unison rings each moveable to vary the pitch of a respective plurality of variable vanes; and a plurality of drive assemblies for driving rotation of the respective unison rings. Each drive assembly may comprise a drive and a flexible line extending from a ring anchor point on the respective unison ring to the drive. The ring anchor point may be positioned such that a portion of the flexible line extending towards the respective drive wraps around the unison ring, whereby tension in the flexible line is applied to the ring anchor point in a direction tangential to the unison ring.

The crankshaft may define a plurality of the drives corresponding to the plurality of unison rings, such that rotation of the crankshaft causes rotation of each of the respective unison rings. The crankshaft may define the drives at spaced apart axial portions of the crankshaft. A drive radius may differ between the drives so that rotation of the crankshaft causes different amounts of rotation of each of the unison rings.

The variable vane actuation arrangement may comprise a plurality of drive assemblies. For example, there may be a plurality of drive assemblies associated with a unison ring. A plurality of flexible lines may extend from a respective plurality of ring anchor points on the unison ring to the respective drives. The plurality of ring anchor points may be evenly distributed around the circumference of the unison ring.

The crankshafts may be linked so that rotation of each crankshaft causes rotation of the or each other crankshaft. The crankshafts may be linked by belts which extend between adjacent crankshafts.

The unison ring may have an angular travel for pivoting variable vanes between a minimum incidence and a maximum incidence. The ring anchor point may be positioned such that a portion of the flexible line extending towards the drive wraps around the unison ring throughout the angular travel.

The drive assembly may comprise two flexible lines for driving rotation of the unison ring in respective opposing directions, each extending from a respective ring anchor point on the unison ring to the drive. Each ring anchor point may be positioned such that a portion of the respective flexible line extending towards the drive wraps around the unison ring, whereby tension in the flexible line is applied to the respective ring anchor point in a direction tangential to the unison ring.

There may be a path tangential to the unison ring extending between a second tangent point on the unison ring to the drive. A second ring anchor point may be disposed on an opposing side of the second tangent point from the drive so that the portion of the respective flexible line extending from the second ring anchor point to the drive wraps around the unison ring and departs the unison ring at the second tangent point.

The variable vane actuation arrangement may comprise at least three drive assemblies distributed around the unison ring. At least three flexible lines may extend from a respective at least three ring anchor points on the unison ring to the respective at least three drives. The ring anchor points may be evenly distributed around the circumference of the unison ring.

The invention may comprise any combination of the features and/or limitations referred to herein, except combinations of such features as are mutually exclusive.

### DESCRIPTION OF THE DRAWINGS

Embodiments of the invention will now be described, by way of example, with reference to the accompanying drawings, in which:

FIG. 1 schematically shows a sectional side view of a gas turbine engine;

FIG. 2 schematically shows a cutaway view of an intermediate pressure compressor section in a gas turbine engine;

FIG. 3a schematically shows an axial cross-sectional view of a variable vane actuation arrangement;

FIG. 3b shows a close-up view of a drive assembly of FIG. 3a; and

FIG. 4 schematically shows a longitudinal view of the variable vane actuation arrangement.

### DETAILED DESCRIPTION

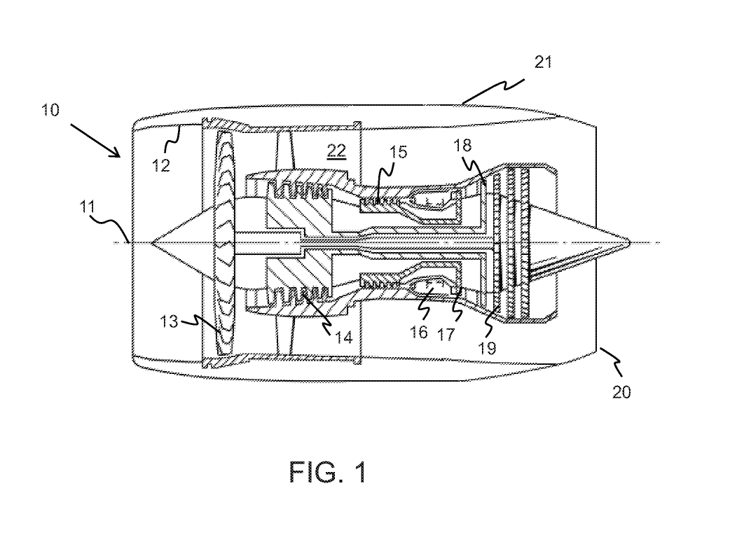

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

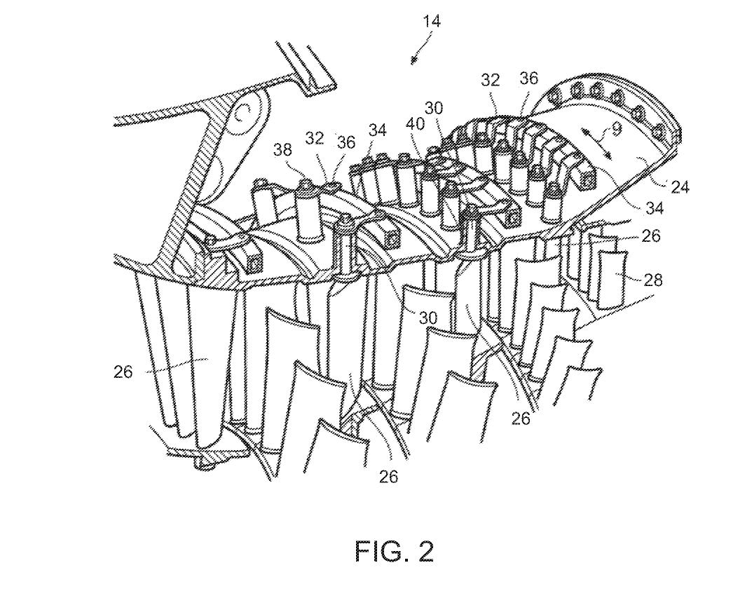

FIG. 2 shows a cutaway view of an example intermediate pressure compressor 14 of the gas turbine engine. In this example, the intermediate pressure compressor 14 has a casing 24 and four successive compression stages, each of which comprises a set of stator vanes 26 and a set of rotor vanes 28 downstream of the set of stator vanes 26.

Each set of stator vanes 26 comprises a plurality of stator vanes 26 which are pivotably mounted to the casing 24 around its circumference and extend radially inwardly from the casing 24. Each set of rotor vanes 28 comprises a plurality of rotor vanes 28 which are mounted to a rotatable support on a shaft (not shown) towards a radial centre of the casing 24, and are rotatable within the casing 24 and around the rotational axis 11 of the engine 10.

The stator vanes 26 are variable stator vanes such that the pitch (or incidence, angle of attack) of the stator vanes 26 can be varied during use to optimise performance of the engine 10. In this example, the stator vanes 26 each comprise a vane stem 30 extending from a radially outer end of the stator vane 26 and through a bush bearing 40 in the casing 24. The vane stems 30 are each coupled to a respective lever 32 by means of a bolt 38 outside the casing 24, the lever 32 extending perpendicularly out from the vane stem 30.

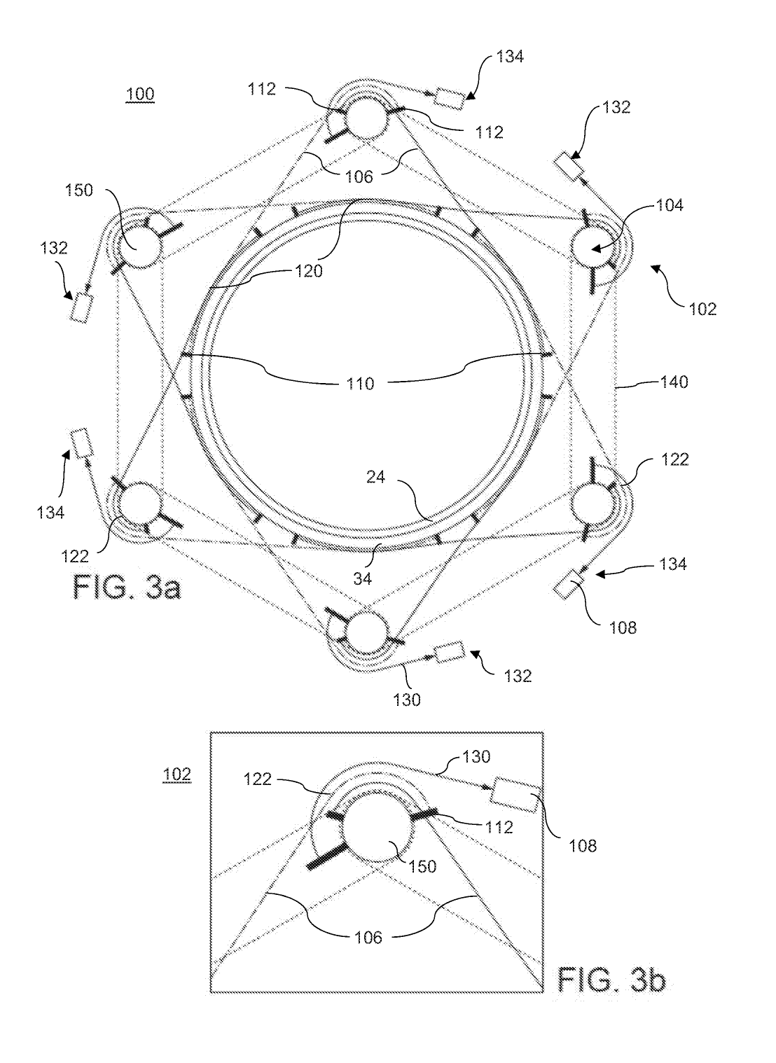

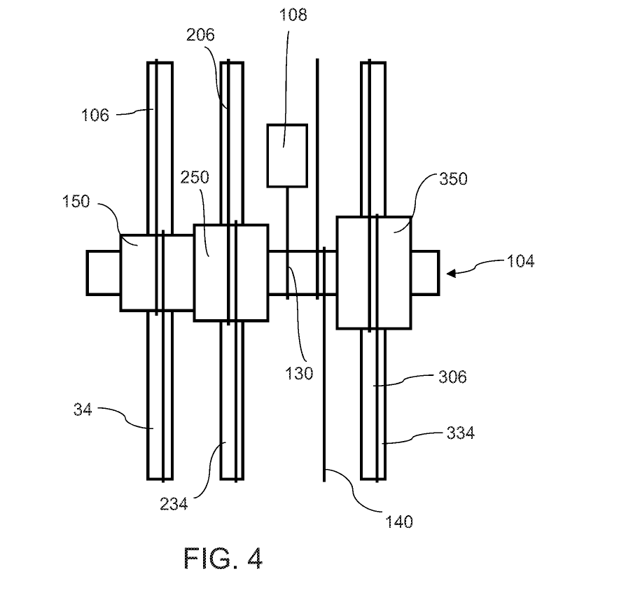

A unison ring 34 extends circumferentially around the casing 24 and is rotatable around the casing 24 by a drive (best shown in FIGS. 3a, 3b, and 4) in directions indicated by arrow 9. Each compression stage has a corresponding unison ring 34.

The levers 32 fixed to the stator vanes 26 in a compression stage are each pivotably coupled to the corresponding unison ring 34 in that compression stage by means of a pin 36.

To change the pitch of the variable stator vanes 26, the unison ring 34 is rotated around the casing 24 in a direction indicated by the arrow 9, causing the levers 32 to pivot, and therefore the stator vanes 26 to pivot and change pitch.

FIGS. 3a and 3b shows an axial cross sectional view of the casing 24 with a variable vane actuation arrangement 100 for a compression stage. The unison ring 34 extends circumferentially around the casing 24 and is concentric with the casing 24.

In this example, the variable vane actuation arrangement 100 comprises six drive assemblies 102 which are each configured to drive rotation of the unison ring 34 around the casing 24. The drive assemblies 102 are configured to operate simultaneously to drive rotation of the unison ring 34. In other examples, there may be one, two or more than two drive assemblies.

Each drive assembly 102 comprises a drive in the form of a crankshaft 104. In this example, the crankshaft 104 associated with each drive assembly 102 extends axially along three compression stages as will be described below with respect to FIG. 4. The crankshaft 104 has three axially spaced crankshaft portions 150 associated with the respective compression stages, each crankshaft portion being substantially axially aligned with the respective compression stage. In this example, there are six crankshaft portions 150 disposed around the unison ring 34 of the compression stage shown in FIG. 3. The respective crankshafts 104 are spaced radially outwardly from the unison ring 34, and are evenly angularly spaced around the unison ring 34. Therefore, in this example, the centres of the crankshafts 104 are each spaced 60 degrees apart from one another around the unison ring 34.

Each drive assembly 102 comprises an actuator 108 for driving the respective crankshaft 104. In this example, there are six actuators 108 in the variable vane actuation arrangement each of which is configured to rotate the respective crankshaft 104 about its axis.

In this example, each drive assembly 102 further comprises two flexible lines 106 which each extend from the respective crankshaft portion 150 in opposing directions to the unison ring 34. In this example, each flexible line 106 is anchored to the unison ring 34 at a ring anchor point 110 and to the crankshaft portion 150 at a crank anchor point 112. Therefore, each crankshaft portion 150 has two crank anchor points 112 to which respective flexible lines 106 are anchored. Each flexible line 106 extending from each crankshaft portion 150 is anchored to the unison ring 34 at a different ring anchor point 110. Therefore, there are 12 ring anchor points 110 in total on the unison ring 34.

The ring anchor points 110 and crank anchor points 112 on the are positioned on the unison ring 34 and the crankshaft portion 150 respectively such that each pair of flexible lines 106 extending in opposing directions from the crankshaft portion 150 are kept taught during use. Rotation of the crankshaft 104 and therefore the crankshaft portion 150 about its axis in either direction therefore causes corresponding rotation of the unison ring 34 around the casing 24.

In other examples, there may be only one flexible line extending between the crankshaft portion 150 and the unison ring 34.

Between each crankshaft portion 150 and the unison ring 34, there exist two linear tangent paths which meet the unison ring 34 at a ring tangent point 120 and the crankshaft portion 150 at a crankshaft tangent point 122. It will be appreciated that the crankshaft portion may have two possible locations for crankshaft tangent points—a radially inner one with respect to the axis of the unison ring, and a radially outer one. In this example, each of the two linear tangent paths meet the crankshaft portion 150 at the radially outer tangent point 122.

For each flexible line 106, the respective ring anchor point 110 is positioned such that the ring anchor point 110 and the corresponding crank anchor point 120 are on opposing sides of the corresponding tangent point 120 on the unison ring 34 in use (i.e. within the respective angular travels of the crankshaft portion 150 and unison ring 34). Accordingly, in use, the flexible line 106 extending from the unison ring 34 to the crankshaft portion 150 extends from the unison ring 34 at the ring anchor point 110 and wraps around the unison ring 34 towards the ring tangent point 120 where the flexible line 106 departs the surface of the unison ring 34. Therefore, between the ring anchor point 110 and the ring tangent point 120, the flexible line 106 lies circumferentially around and against the unison ring 34. When a force is applied to the flexible line 106, the resulting tension in the flexible line is applied to the unison ring 34 at a tangent to the unison ring 34 at the ring anchor point 110 (i.e. a local tangent at the ring anchor point).

In this example, the crank anchor point 112 for each flexible line 106 is positioned on the crankshaft portion 150 so that the crank anchor point 112 and the corresponding ring anchor point 110 are on opposing sides of the crank tangent point 122 in use (i.e. within the respective angular travels of the crankshaft portion 150 and the unison ring 34). Therefore, the flexible line 106 extending from the unison ring 34 to the crankshaft portion 150 meets the crankshaft at the crank tangent point 122 and wraps around the crankshaft portion 150 towards the crank anchor point 112. Therefore, between the crank tangent point 122 and the crank anchor point 112, the flexible line 106 lies circumferentially around and against the crankshaft portion 150 (i.e. it is wrapped around the crankshaft portion 150).

Each flexible line 106 departs the crankshaft portion 150 and the unison ring 34 at the corresponding crank tangent point 122 and the ring tangent point 120 respectively, so that each of the two flexible lines 106 anchored to each crankshaft portion 150 follows one of the corresponding linear tangent paths between that crankshaft portion 150 and the unison ring 34.

The unison ring 34 is configured to have a total angular travel of approximately 5 degrees, which corresponds to pivoting the variable stator vanes 26 between a minimum incidence and a maximum incidence. Within this angular travel, the positions of the ring anchor point 110 and the crank anchor point 112 are such that portions of the flexible lines 106 are always wrapped around the unison ring 34 and the crankshaft portion 150.

The unison ring 34 in this example has a diameter approximately eight times larger than the diameter of each of the crankshaft portions 150. Since the flexible lines 106 depart the unison ring 34 and crankshaft tangentially throughout the angular travel of the unison ring 34, there is a proportional relationship between rotation of the crankshaft portion 150 and rotation of the unison ring 34. In this example, the relationship is such that the crankshaft portion 150 has an angular travel of 40 degrees to rotate the unison ring by 5 degrees. In this example the angular travel of the crankshaft portion 150 is limited to 40 degrees by the respective actuator. In other examples, there may be mechanical stops engaging the crankshaft or the actuator to limit the angular travel.

Each of the actuators 108 is connected to a respective crankshaft 104 by a flexible actuation line 130. The flexible actuation line 130 is connected to the crankshaft 104 in a similar manner to the flexible lines 106 extending between the crankshaft portion 150 and the unison ring 34, such that a portion of the flexible actuation line 130 wraps around the crankshaft 104 throughout the angular travel of the crankshaft portion 150.

Each actuator 108 is configured to apply a tension to the flexible actuation line 130 to which it is attached. The tension in the flexible actuation line 130 is transferred tangentially to the crankshaft 104, which causes rotation of the crankshaft 104 and therefore the crankshaft portion 150 about its axis. Since the actuators 108 and the crankshaft 104 are connected by a flexible actuation line 130, the actuators 108 in this example can only cause rotation of their respective crankshafts 104 in one direction.

However, in other examples two such actuation lines 130 may be connected between an actuator 108 and a respective crankshaft 104 to effect rotation in both directions.

A first set 132 of actuators 108 comprising three of the actuators 108 in the variable vane actuation arrangement 100 are positioned such that the tension in the flexible lines 130 cause rotation of the crankshaft portions 150 in a first direction (an anti-clockwise direction in FIG. 3) and therefore cause rotation of the unison ring 34 in the first direction. A second set 134 of actuators comprising the other three actuators 108 are positioned such that the tension in the flexible lines 130 causes rotation of the crankshaft portions 150 in a second direction which is opposite the first direction (a clockwise direction in FIG. 3), and therefore causes rotation of the unison ring 34 in the second direction.

In this example, the first set 132 of actuators 108 are connected to three crankshafts 104 which are equally angularly spaced from one another. In other words, the first set of actuators 132 is connected to three crankshafts 104 which are spaced 120 degrees from one another around the unison ring 34. In other examples, the crankshafts 104 may be irregularly spaced around the unison ring.

The second set 134 of actuators 108 are connected to the other three crankshafts 104 which are also equally angularly spaced around the unison ring 34, so that they are spaced 120 degrees apart from one another.

Therefore, in this example actuators 108 in the first set 132 and actuators 108 in the second set 134 are spaced in alternating sequence around the unison ring 34.

In this example, each of the crankshafts 104 is also connected to two adjacent crankshafts 104 on either side by means of belts 140. A belt 140 extends around a crankshaft 104 and an adjacent crankshaft 104 so that rotation of one crankshaft 104 causes rotation of the adjacent crankshafts 104. This introduces some redundancies in the actuation arrangement 100, and may prevent uneven rotation between the respective crankshafts.

In other examples, there may be no belts connecting adjacent crankshafts, or there may be one or more belts between selected ones of the adjacent pairs of crankshafts.

In use, the first set 132 of actuators 108 are operated to drive rotation of the respective crankshafts 104 in the first direction, thereby causing the unison ring 34 to turn in the first direction. In this example, the second set 134 of actuators 108 are configured to feed out the respective flexible actuation lines 130 to permit rotation of the respective crankshafts 104, which follow the rotation of the unison ring 34 and/or adjacent crankshafts 104.

For opposing rotation, the second set 134 of actuators 108 are operated to drive rotation of the respective crankshafts 104 in the second direction, thereby causing the unison ring 34 to turn in the second direction. Again, the first set 132 of actuators 108 are configured to feed out the respective flexible actuation lines 130 to permit rotation of the respective crankshafts 104, which follow the rotation of the unison ring 34 and/or adjacent crankshafts 104.

In other examples, an actuator may be connected to a respective crankshaft by means of an actuation rod, so that the or each actuator may drive rotation of the corresponding crankshaft about its axis in both the first and the second directions. Where a plurality of actuators are provided, each may operate simultaneously to drive rotation of the respective crankshafts. In yet further examples, there may only be one, or there may be two or more than two actuators to drive rotation of the crankshafts.

Actuation of the first set 132 of actuators 108 causes tension in a corresponding first set of flexible lines 106. The ring anchor points 110 corresponding to the first set of flexibles lines 106 are evenly distributed around the circumference of the unison ring 34. Therefore, when actuators 108 of the first set 132 are actuated to drive rotation of their respective crankshafts 104 in the first direction, the corresponding first set of flexible lines 106 transfer the tension in the lines to the unison ring 34 at equally spaced intervals around the unison ring 34 and tangentially to the unison ring 34 at the ring anchor points 110. In particular as a portion of each flexible line 106 extending from the respective ring anchor point 110 towards the respective crankshaft portion 150 wraps around the unison ring, it follows that the flexible line extends from the ring anchor point 110 along a tangential direction.

Actuation of the second set 134 of actuators 108 causes tension in a corresponding second set of flexible lines 106. The ring anchor points 110 corresponding to the second set of flexible lines 106 are evenly distributed around the circumference of the unison ring 34 in a similar manner to the first set of flexible lines 106.

Therefore, when the first set 132 or second set 134 of actuators 108 drive rotation of the crankshafts 104 and therefore of the unison ring 34, the forces applied to the unison ring 34 are tangential to the unison ring 34. This may prevent distortion of the unison ring 34 owing to actuation. In contrast, in previously considered arrangements in which a control rod connects with a portion of a unison ring to drive rotation back and forth, the control rod is necessarily inclined with respect to a tangential direction and therefore may introduce loads into the unison ring having a radial component.

Further, as the ring anchor points 110 associated with each respective set of actuators are equally angularly space around the circumference of the unison ring 34, the loads imparted on the unison ring are evenly distributed. This may prevent uneven distortion of the unison ring around it's circumference.

It may be desirable to minimise distortion of the unison ring in order that each of the respective vanes is held at equal pitch (i.e. angle of incidence), so as to achieve equal aerodynamic performance around the annulus.

Although the above description of an actuation arrangement is with respect to a first compressor stage, it should be appreciated that like arrangements may be provided in any compressor stage in which the pitch of variable stator vanes is to be controlled.

FIG. 4 schematically shows a simplified axial view of the example variable vane actuation arrangement 100. In this example, the variable vane actuation arrangement 100 is configured to control the pitch of variable stator vanes in three compressor stages simultaneously. Each of the compressor stages have arrangements as described above with reference to FIGS. 3a and 3b for rotating a respective unison ring. Each compressor stage comprises a unison ring 34, 234, 334. As described above, for each compressor stage there are six drive assemblies 102 (one shown per compression stage in FIG. 4), each having a respective crankshaft portion 150, 250, 350 defined by a respective crankshaft.

For simplicity, whilst the example actuation arrangement 100 includes six crankshafts 104, one example crankshaft 104 is shown in FIG. 4. The crankshaft 104 comprises crankshaft portions 150, 250, 350 corresponding to the three different compression stages, each crankshaft portion being defined by a respective axial portion of the crankshaft 104 axially aligned with a respective unison ring 34, 234, 334. Each crankshaft portion 150, 250, 350 has two crankshaft anchor points and two flexible lines 106, 206, 306 which extend in opposing directions from the crankshaft anchor points on the crankshaft portions 150, 250, 350 to the ring anchor points on the corresponding unison ring 34, 234, 334, and which wrap around the respective crankshaft portions 150, 250, 350 and unison rings 34, 234, 334.

As described with reference to FIGS. 3a and 3b, the crankshaft 104 is linked to adjacent crankshafts 104 by belts 140 and connected to an actuator 108 by a flexible line 130. Therefore, actuation of the actuator 108 to drive rotation of the crankshaft 104 causes rotation of the three crankshaft portions 150, 250, 350 and therefore rotation of the unison rings 34, 234, 334.

In this example, the crankshaft portions 150, 250, 350 each have different radii so that rotation of the crankshaft 104 by the actuator 108 causes different amounts of rotation of the three unison rings 34, 234, 334. Accordingly the variable vanes of the respective compression stages can be pivoted at different rates per unit rotation of the crankshaft 104.

In other examples, only some of the crankshaft portions may have the same radius.

Although it has been described that the crankshaft can control three stages of compression simultaneously, it should be appreciated that the crankshaft can extend longitudinally to control any number of compression stages simultaneously.

We claim:

1. A variable vane actuation arrangement comprising:
a unison ring moveable to vary the pitch of a plurality of variable vanes; and
a drive assembly for driving rotation of the unison ring, comprising a drive and a flexible line extending from a ring anchor point on the unison ring to the drive;
wherein the ring anchor point is positioned such that a portion of the flexible line extending towards the drive wraps around the unison ring, whereby tension in the flexible line is applied to the ring anchor point in a direction locally tangential to the unison ring.

2. A variable vane actuation arrangement according to claim 1, the actuation arrangement further comprising an actuator configured to actuate the drive.

3. A variable vane actuation arrangement according to claim 2, wherein the drive assembly comprises a flexible line extending from a crank anchor point on the crankshaft to the actuator, wherein the crank anchor point is positioned such that a portion of the flexible line extending towards the actuator wraps around the crankshaft, whereby tension in the flexible line is applied to the crank anchor point in a direction tangential to the crankshaft.

4. A variable vane actuation arrangement according to claim 1, wherein the drive is defined by a crankshaft.

5. A variable vane actuation arrangement according to claim 4, wherein there are a plurality of unison rings each moveable to vary the pitch of a respective plurality of variable vanes; and
a plurality of drive assemblies for driving rotation of the respective unison rings, each drive assembly comprising a drive and a flexible line extending from a ring anchor point on the respective unison ring to the drive;
wherein the ring anchor point is positioned such that a portion of the flexible line extending towards the respective drive wraps around the unison ring, whereby tension in the flexible line is applied to the ring anchor point in a direction tangential to the unison ring; and
wherein a crankshaft defines a plurality of the drives corresponding to the plurality of unison rings, such that rotation of the crankshaft causes rotation of each of the respective unison rings.

6. A variable vane actuation arrangement according to claim 5, wherein the crankshaft defines the drives at spaced apart axial portions of the crankshaft, wherein a drive radius differs between the drives so that rotation of the crankshaft causes different amounts of rotation of each of the unison rings.

7. A variable vane actuation arrangement according to claim 1, comprising a plurality of drive assemblies, wherein a plurality of flexible lines extend from a respective plurality of ring anchor points on the unison ring to the respective drives, and wherein the plurality of ring anchor points are evenly distributed around the circumference of the unison ring.

8. A variable vane actuation arrangement according to claim 7 when appendant to claim 3, wherein the crankshafts are linked so that rotation of each crankshaft causes rotation of the or each other crankshaft.

9. A variable vane actuation arrangement according to claim 8, wherein the crankshafts are linked by belts which extend between adjacent crankshafts.

10. A variable vane actuation arrangement according to claim 1, wherein the unison ring has an angular travel for pivoting variable vanes between a minimum incidence and a maximum incidence; and wherein the ring anchor point is positioned such that a portion of the flexible line extending towards the drive wraps around the unison ring throughout the angular travel.

11. A variable vane actuation arrangement according to claim 1, wherein the drive assembly comprises two flexible lines for driving rotation of the unison ring in respective opposing directions, each extending from a respective ring anchor point on the unison ring to the drive, wherein each ring anchor point is positioned such that a portion of the respective flexible line extending towards the drive wraps around the unison ring, whereby tension in the flexible line is applied to the respective ring anchor point in a direction tangential to the unison ring.

12. A variable vane actuation arrangement according to claim 1, comprising at least three drive assemblies distributed around the unison ring, wherein at least three flexible lines extend from a respective at least three ring anchor points on the unison ring to the respective at least three drives, and wherein the ring anchor points are evenly distributed around the circumference of the unison ring.

13. A gas turbine engine comprising a variable stator vane stage comprising a variable vane actuation arrangement according to claim 1.
